(19) United States
(12) Patent Application Publication
(10) Pub. No.: US 2025/0156080 A1
(43) Pub. Date: May 15, 2025

(54) COORDINATING AN UNPLANNED SWAP EVENT ACROSS MULTIPLE COMPUTING CLUSTERS

(71) Applicant: INTERNATIONAL BUSINESS MACHINES CORPORATION, ARMONK, NY (US)

(72) Inventors: WILLIAM C. SHEPARD, HYDE PARK, NY (US); TABOR R. POWELSON, POUGHKEEPSIE, NY (US); TRI M. HOANG, POUGHKEEPSIE, NY (US); TARIQ HANIF, LAGRANGEVILLE, NY (US)

(21) Appl. No.: 18/509,628

(22) Filed: Nov. 15, 2023

(51) Int. Cl. G06F 3/06

(52) U.S. Cl. CPC G06F 3/0614; G06F 3/0635; G06F 3/067

(57) ABSTRACT

Coordinating an unplanned swap event across multiple computing clusters includes receiving a notification from each of a plurality of computing clusters through a shared storage device of a set of storage devices. The notification identifies which of a first set of target storage devices and a second set of target storage devices that a particular computing cluster of the plurality of computing clusters is capable of swapping to from a set of source storage devices. Based on the notification from each of the plurality of computing clusters, it is determined whether the plurality of computing clusters will swap from usage of the set of source storage devices to the first set of target storage devices or to the second set of target storage devices during a swap event.

### BACKGROUND

The present disclosure relates to methods, apparatus, and products for coordinating an unplanned swap event across multiple computing clusters.

### SUMMARY

According to embodiments of the present disclosure, various methods, apparatus and products for coordinating an unplanned swap event across multiple computing clusters are described herein. In some aspects, coordinating an unplanned swap event across multiple computing clusters includes receiving a notification from each of a plurality of computing clusters through a shared storage device of a set of storage devices. The notification identifies which of a first set of target storage devices and a second set of target storage devices that a particular computing cluster of the plurality of computing clusters is capable of swapping to from a set of source storage devices. Based on the notification from each of the plurality of computing clusters, it is determined whether the plurality of computing clusters will swap from usage of the set of source storage devices to the first set of target storage devices or to the second set of target storage devices during a swap event.

### BRIEF DESCRIPTION OF THE DRAWINGS

FIG. 1 sets forth an example computing environment according to aspects of the present disclosure.

FIG. 2 sets forth another example computing environment according to aspects of the present disclosure.

FIG. 3 sets forth a flowchart of an example process for host device load time replication configuration according to aspects of the present disclosure.

FIG. 4 sets forth a flowchart of an example process for unplanned swap host processing according to aspects of the present disclosure.

FIG. 5 sets forth a flowchart of an example process for storage controller processing to set replication status according to aspects of the present disclosure.

FIG. 6 sets forth a flowchart of an example process of remaining steps of an unplanned swap according to aspects of the present disclosure.

FIG. 7 sets forth an example sysplex replication status setting command according to aspects of the present disclosure.

FIG. 8 sets forth an example sysplex replication status query according to aspects of the present disclosure.

FIG. 9 sets forth a flowchart of an example process for coordinating an unplanned swap event across multiple computing clusters according to aspects of the present disclosure.

FIG. 10 sets forth a flowchart of another example process for coordinating an unplanned swap event across multiple computing clusters according to aspects of the present disclosure.

### DETAILED DESCRIPTION

A computing system is often in communication over a network with one or more storage systems for storing and accessing data used during operation of the computing system. The different storage systems are often located in different geographical locations. Each storage system typically includes one or more storage devices (e.g., disk drives) controlled by a storage controller. Storage replication allows for maintaining redundant copies of data on two different storage systems to allow for continuous availability in the event of a failure of one of the storage systems. Switching from usage of one storage system to another storage system is often referred to as a swap event. The switching from one storage system to another storage system in the event of a failure of the storage system is often referred to as an unplanned swap event. An example of an operating system including such swap capability is the HyperSwap function provided by the z/OS operating system offered by International Business Machines™. A sysplex refers to a computing cluster of independent instances of the z/OS operating system. The HyperSwap function provides for continuous availability in the event of disk failures by maintaining synchronous copies of all primary disk volumes on one or more secondary storage controllers. During data replication, data is copied from a source volume to one or more target volumes. The source volume and target volumes that contain copies of the same data are collectively referred to as a copy set. Disk failures can be hidden from applications by the HyperSwap function automatically swapping form one set of disk volumes to another as a result of triggering a swap event.

In a sysplex environment, it is often desirable for a sysplex user to have dedicated volumes to store data such as applications and databases that are critical for operation, and some volumes shared with other sysplexes that contain less critical data. On existing sysplexes, their respective swap functions are independent from one another, and cannot easily communicate with each other as such functionality would require implementing a communications protocol across sysplexes whose code path is hardened so that it will function during swap when paging packs and other system volumes are frozen. Accordingly, a procedure to allow for multiple independent computing clusters (e.g., sysplexes) to be able to swap to their respective targets without interfering with each other is desired. Specifically, allowing for multiple computing clusters to gain a collective understanding of which set of target storage devices that the computing cluster will swap to when a swap event occurs and a way to tolerate disagreements is desired. Often it is not desirable to allow multiple computing clusters to swap to different target volumes due to the use of shared storage devices among the computing clusters. Each computing cluster could possibly modify data on the shared devices without it being reflected for the other computing clusters, causing an inconsistent view of data. For a sysplex environment, a given sysplex may not be able to swap to its preferred target if it loses for example, a fiber connection (FICON) to a source storage device located proximate to a computing cluster or a peer-to-peer remote copy (PPRC) connection to a target storage device.

One or more embodiments provide for a method of allowing unplanned swap (e.g., HyperSwap) in an environment with multiple computing clusters (e.g., sysplexes) involved with shared storage devices between the computing clusters, and with multiple sets of PPRC secondary storage devices. In particular embodiments, a collective understanding among multiple computing clusters of which set of target devices is being swapped to is created and communicated through attention interrupts through the shared storage devices. In a particular embodiment, at configuration load time, each computing cluster uses Query Host Access messages to determine which pairs of storage devices are shared to another computing cluster. When a swap event occurs, a given computing cluster first tests for FICON path access to multiple target storage devices to determine to which leg it can swap. In various embodiments, a leg refers to a relationship between the source devices and the target devices. In the particular embodiment, the computing cluster then issues an input/output (I/O) including a Set Sysplex Replication Status message to all shared storage devices. The Set Sysplex Replication Status message prompts a storage controller associated with the storage devices to raise attention interrupts to all attached host devices which use a Query Sysplex Replication Status request to read the result.

In one or more embodiments, if all computing clusters reach agreement regarding which leg of target storage devices the computing clusters can be swapped to, the computing clusters will swap to that leg of target storage devices. If two or more of the computing clusters cannot swap to the same leg of target storage devices, data consistency and system operations are maintained by disabling or “boxing” of the shared storage devices. Rather than having to fully shutdown a computing cluster that cannot swap to the leg where all other computing clusters are swapping to, the computing cluster is allowed to swap to the leg that it is able to swap to while the shared storage devices on the leg are disabled for access by the computing cluster (i.e., “boxed”).

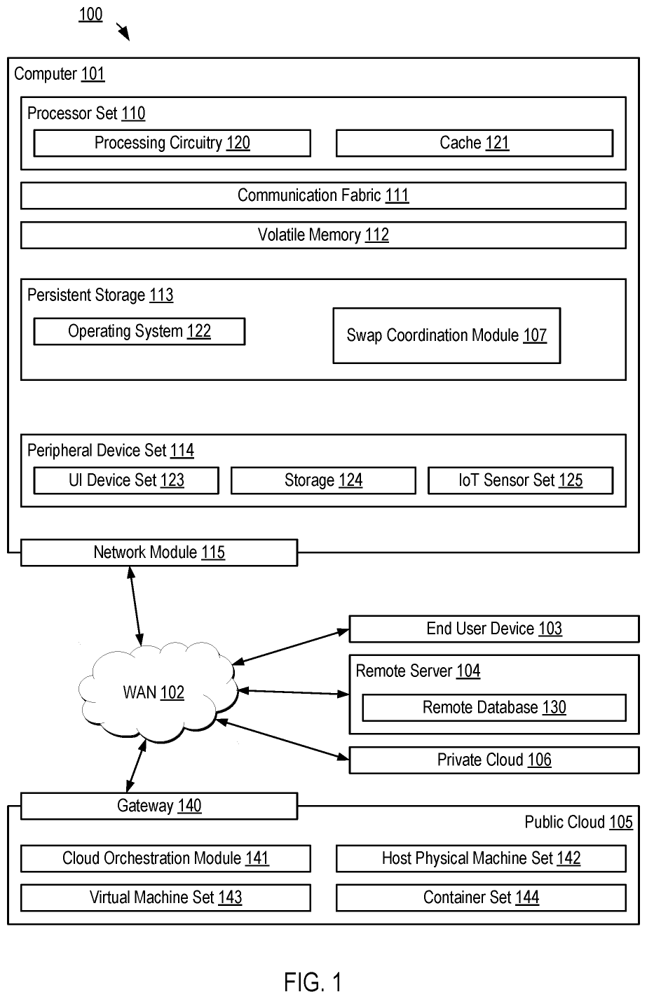

With reference now to FIG. 1, FIG. 1 sets forth an example computing environment according to aspects of the present disclosure. Computing environment 100 contains an example of an environment for the execution of at least some of the computer code involved in performing the various methods described herein, such as swap coordination module 107. In addition to swap coordination module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and swap coordination module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Such computer processors as well as graphic processors, accelerators, coprocessors, and the like are sometimes referred to herein as a processing device. A processing device and a memory operatively coupled to the processing device are sometimes referred to herein as an apparatus. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in swap coordination module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in swap coordination module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

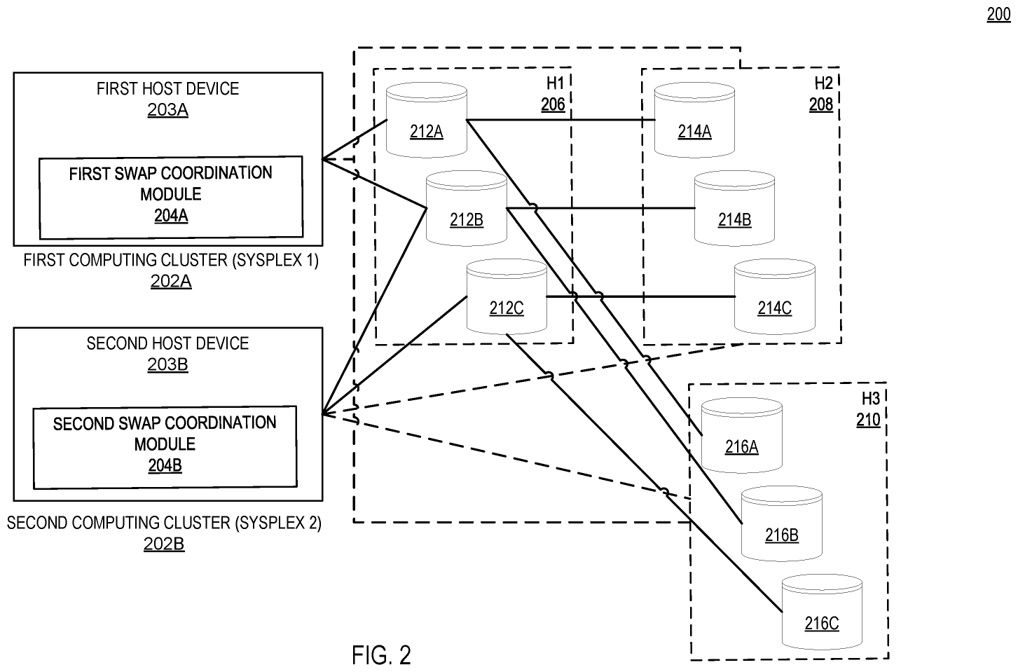

Referring now to FIG. 2, FIG. 2 sets forth another example computing environment according to aspects of the present disclosure. Computing environment 200 includes a first computing cluster (Sysplex 1) 202A having a first host device 203A and a second computing cluster (Sysplex 2) 202B having a second host device 203B. In a particular embodiment, the first host device 203A and the second host device 203B includes the computer 101 described with respect to FIG. 1. The first host device 203A includes a first swap coordination module 204A and the second host device 203B includes a second swap coordination module 204B. In a particular embodiment, the first swap coordination module 204A and the second swap coordination module 204B includes the swap coordination module 107 described with respect to FIG. 1.

The first computing cluster 202A and the second computing cluster 202B are each in communication with a set of source storage devices (or volumes) (H1) 206. In a particular embodiment, each of first computing cluster 202A and the second computing cluster 202B are in communication with the set of source storage devices 206 via FICON connections. The set of source storage devices 206 are in communication with a first set of target storage devices (or volumes) (H2) 208 and a second set of target storage devices (or volumes) (H3) 210. In a particular embodiment, the set of source storage devices 206 are in communication with the first set of target storage devices 208 and the second set of target storage devices 210 via PPRC connections. Each of the first computing cluster 202A and the second computing cluster 202B are further in communication with the first set of target storage devices 208 and a second set of target storage devices 210. In a particular embodiment, each of the set of source storage devices 206, the first set of target storage devices 208, and the second set of target storage devices 210 are each located at a different location or site. In particular embodiments, a user may define a priority order for the first set of target storage devices 208 and the second set of target storage devices 210 such designating that it is more preferable to swap to the first set of target storage devices 208 rather than the second set of target storage devices 210 during an unplanned swap event (e.g., due to the first set of target storage devices 208 being closer than the second set of target storage devices 210) to the particular computing cluster. In one or more embodiments, each of the set of source storage devices 206, the first set of target storage devices 208, and the second set of target storage devices 210 include one or more associated storage controllers (not shown).

The set of source storage devices 206 includes source storage devices 212A-212C in which source storage device 212A is a dedicated source storage device for the first computing cluster 202A, the source storage device 212C is a dedicated source storage device for the second computing cluster 202B, and the source storage device 212B is a shared source storage device by both the first computing cluster 202A and the second computing cluster 202B. The first set of target storage devices 208 includes target storage devices 214A-214C in which target storage device 214A is a dedicated target storage device for the first computing cluster 202A, the target storage device 214C is a dedicated target storage device for the second computing cluster 202B, and the target storage device 214B is a shared target storage device by both the first computing cluster 202A and the second computing cluster 202B. The second set of target storage devices 210 includes target storage devices 216A-216C in which target storage device 216A is a dedicated target storage device for the first computing cluster 202A, the target storage device 216C is a dedicated target storage device for the second computing cluster 202B, and the target storage device 216B is a shared target storage device by both the first computing cluster 202A and the second computing cluster 202B. Although various embodiments are illustrated using two computing clusters and two sets of target storage devices for simplicity of explanation, in other embodiments more than two computing clusters and more than two sets of target storage devices are used.

In an example operation, the first computing cluster 202A and the second computing cluster 202B send notifications through the shared storage devices (e.g., source storage device 212B, target storage device 214B, and target storage device 216B) to communicate which sets of target storage devices (e.g., the first set of target storage devices 208 and the second set of target storage devices 210) the particular computing cluster is capable of swapping to from the set of source storage devices 206. By sending the notification through each of the shared storage devices, redundancy is provided to allow for situations in which at least one of the shared storage devices may be unavailable. In a particular example, source storage device 212B may be unavailable during an unplanned HyperSwap event. In a particular embodiment, unsolicited attention interrupts are used to notify the hosts of each computing cluster's swap capabilities. The results of the communication are used to arrive at a collective understanding of which sets of target storage devices every computing cluster will swap to (e.g., the first set of target storage devices 208) during an unplanned swap event. If one of the computing clusters has to swap to a different target storage device than the other computing clusters, a boxed status is set for the shared swap-to storage devices to disable the shared swap-to storage devices. In a particular embodiment, a unit control block (UCB) is utilized to set a boxed status (UCBBOX) for the shared swap-to storage devices. The UCB describes the storage device to the operating system of the host device.

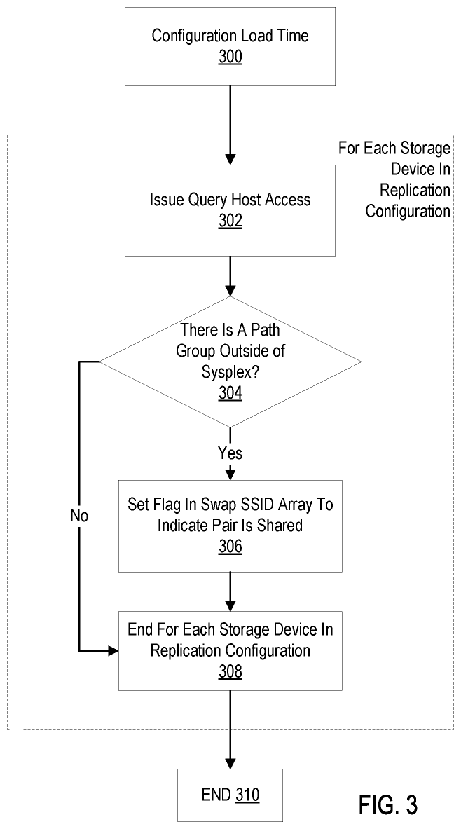

Referring now to FIG. 3, FIG. 3 sets forth a flowchart of an example process for host device load time replication configuration according to aspects of the present disclosure. During a configuration load time 300, for each storage device in a replication configuration the host device issues 302 a Query Host Access command to the storage device to determine the online status and the path group of the storage device. The host device determines 304 whether any of the path groups of the storage device are outside of the sysplex. If no path group is outside of the sysplex the procedure ends 308 for the storage device in the replication configuration. If there is a path group outside of the sysplex, the host sets 306 a flag in a subsystem identifier (SSID) array to indicate that the storage device pair is shared. The process then ends 308 for the storage device in the replication configuration. When all storage devices in the replication configuration have been queried, the process ends 310.

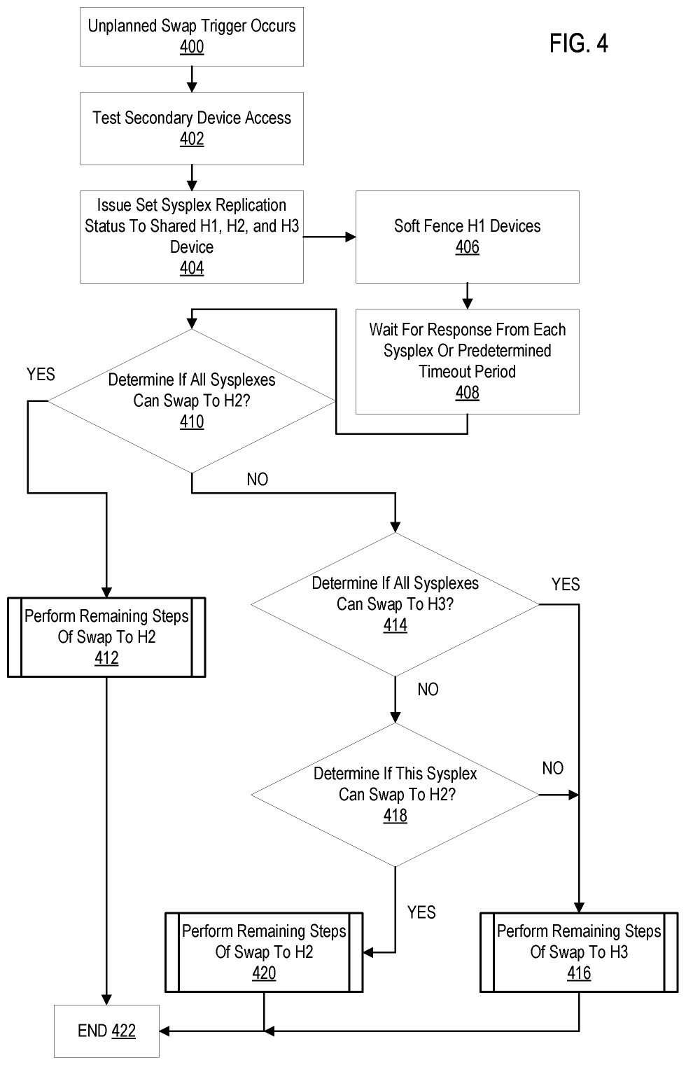

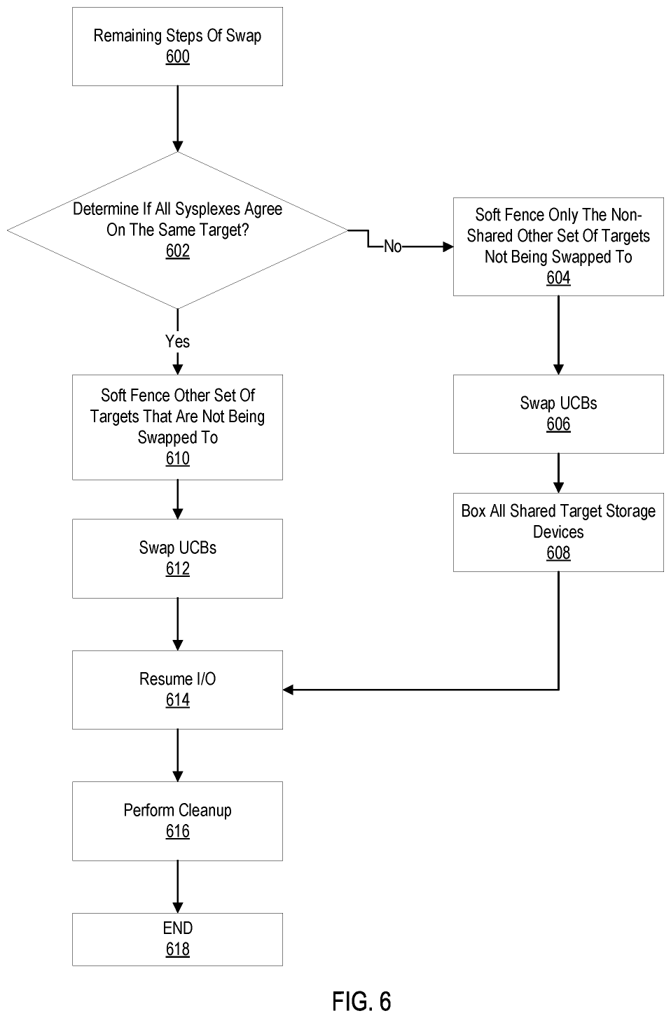

Referring now to FIG. 4, FIG. 4 sets forth a flowchart of an example process for unplanned swap host processing according to aspects of the present disclosure. An unplanned swap trigger occurs 400 and the host device tests 402 secondary device access to determine if the first set of storage devices (H2) 208 and the second set of storage devices (H3) 210 are online. The host device issues 404 a set sysplex replication status to the shared H1, H2, and H3 devices. If the other sysplexes either were not already triggered to swap, they are triggered to swap by the set sysplex replication status attention interrupt. Issuing the set sysplex replication status triggering the other sysplexes to swap, if not already triggered, assists in enabling all sysplexes to swap in a timely manner. The host device then soft fences 406 the H1 devices to prevent access. Soft fencing prevents unintended access to the storage device by preventing most I/O operations (e.g., reading and writing data) to the storage device. The host device waits 408 for a response from each sysplex or for a predetermined time period. The host device determines 410 if all sysplexes can swap to the first set of target storage devices 208 (H2). If all sysplexes can swap to the first set of target storage devices 208 (H2), the host device performs 412 the remaining steps of a swap to the first set of target storage devices 208 (H2) and the process ends 422. The remaining steps of a swap are further described with respect to FIG. 6 below.

If not all sysplexes can swap to the first set of target storage devices 208 (H2), the host device determines 414 if all sysplexes can swap to the second set of target storage devices 210 (H3). If all sysplexes can swap to the second set of target storage devices 210 (H3), the host device performs 416 the remaining steps of a swap to the second set of target storage devices 210 (H3) and the process ends 422. If all sysplexes cannot swap to the second set of target storage devices 210 (H3), the host device determines 418 if this sysplex can swap to the first set of target storage devices 208 (H2). If this sysplex cannot swap to the first set of target storage devices 208 (H2), the host device performs 416 the remaining steps of the swap to the second set of target storage devices 210 (H3) and the process ends 422. If this sysplex can swap to the first set of target storage devices 208 (H2), the host device performs 420 the remaining steps of a swap to the first set of target storage devices 208 (H2) and the process ends 422.

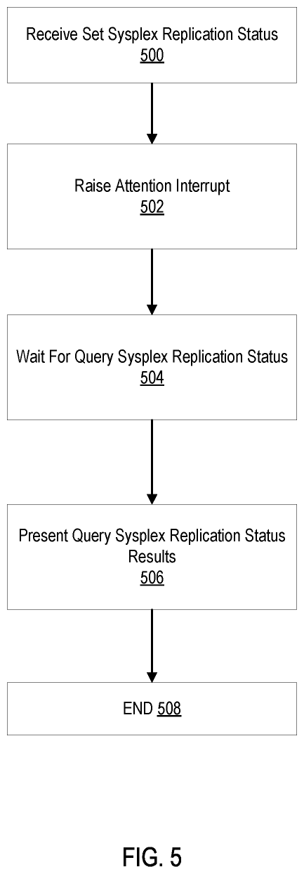

Referring now to FIG. 5, FIG. 5 sets forth a flowchart of an example process for storage controller processing to set replication status according to aspects of the present disclosure. In one or more embodiments, the operations of FIG. 5 are performed by a storage controller of a set of target storage devices. The storage controller receives 500 a set sysplex replication status command and raises 502 an attention interrupt to all attached host devices. The storage controller waits 504 for a query sysplex replication status command from a host device and presents 506 the query sysplex replication status results to the host device. The query sysplex replication status results contain the sysplex replication status information so far received from each sysplex. The procedure then ends 508.

Referring now to FIG. 6, FIG. 6 sets forth a flowchart of an example process of remaining steps of an unplanned swap according to aspects of the present disclosure. In one or more embodiments, the operations of FIG. 6 are performed by a host device of a computing cluster. The remaining steps 600 of a swap as previously described with respect to FIG. 4 includes determining 602, by the host device, if all sysplexes agree on the same set of target storage devices. If all sysplexes do not agree on the same set of target storage devices, the host device soft fences 604 only the non-shared other set of target storage devices not being swapped to. The host device swaps 606 the UCBs to redirect from the source storage devices to the target storage devices, and boxes 608 all shared target (H2 and H3) storage devices. The host device then resumes 614 normal input/output (I/O) operations.

If all sysplexes agree on the same set of target storage devices, the host device soft fences 610 the other set of target storage devices that are not being swapped to. The host device swaps 612 UCBs to redirect from the source storage devices to the target storage devices and resumes 614 normal I/O operations. After resuming I/O normal operations, the host device performs 616 cleanup of the source (H1) storage devices, and the process ends 618.

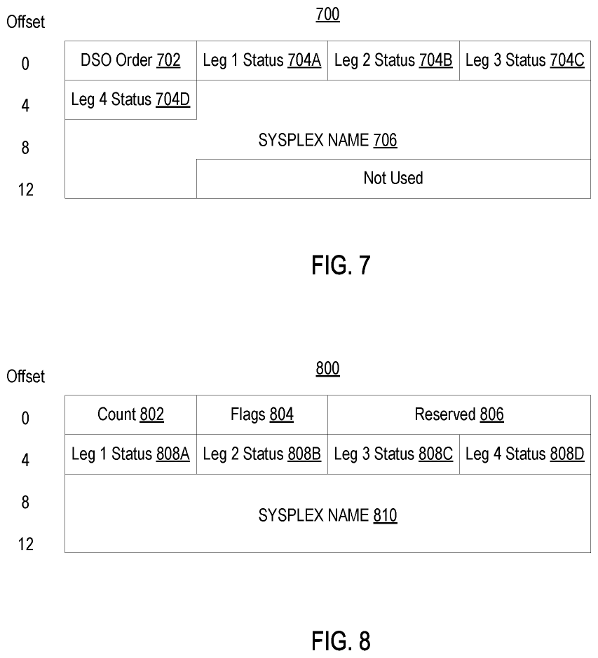

Referring now to FIG. 7, FIG. 7 sets forth an example sysplex replication status setting command 700 according to aspects of the present disclosure. The sysplex replication status setting command 700 includes a define subsystem order (DSO) order field 702, a first leg status fields 704A, a second leg status field 704B, a third leg status field 704C, and a fourth leg status field 704D for status of each of Leg 1, Leg 2, Leg 3, and Leg 4. The status of a leg represents whether the leg is enabled for swap operations. The sysplex replication status setting command 700 further includes a sysplex name field 706 identifying the sysplex.

FIG. 8 sets forth an example sysplex replication status query 800 according to aspects of the present disclosure. The sysplex replication status query 800 is a response to a response to read subsystem data and includes a count field 802, flags field 804, a reserved field 806, and a first leg status field 808A, a second leg status field 808B, a third leg status field 808C, and a fourth leg status field 808D for status of each of Leg 1, Leg 2, Leg 3, and Leg 4. The sysplex replication status query 800 further includes a sysplex name field 810 identifying the sysplex. The count field 802 represents the number of sysplex entries that are returned with each leg status field 808A, 808B, 808C, and 808D, and the sysplex name repeated for each sysplex.

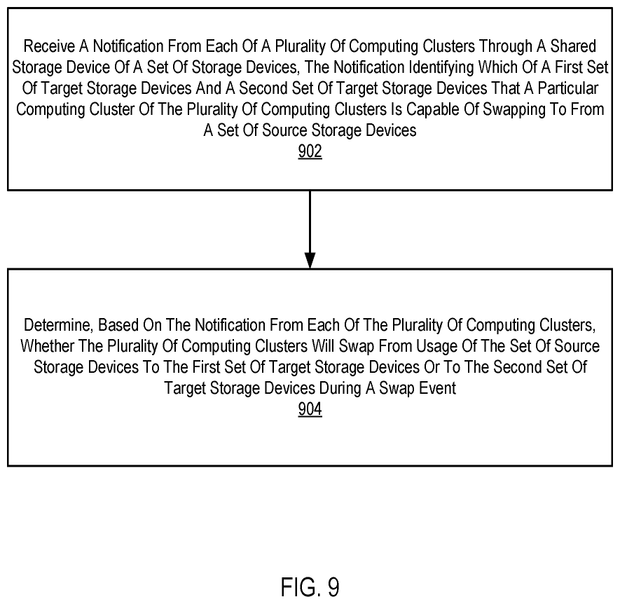

Referring now to FIG. 9, FIG. 9 sets forth a flowchart of an example process for coordinating an unplanned swap event across multiple computing clusters according to aspects of the present disclosure. A host device receives 902 a notification from each of a plurality of computing clusters through a shared storage device of a set of storage devices. The notification identifies which of a first set of target storage devices and a second set of target storage devices that a particular computing cluster of the plurality of computing clusters is capable of swapping to from a set of source storage devices. In a particular embodiment, the notification comprises an attention interrupt message.

The host device determines 904, based on the notification from each of the plurality of computing clusters, whether the plurality of computing clusters will swap from usage of the set of source storage devices to the first set of target storage devices or to the second set of target storage devices during a swap event.

In some embodiments, a request message is sent to a storage device associated with each of the plurality of computing clusters, and a response message is received from the storage device identifying host devices that are utilizing the storage device. In a particular embodiment, the request message is a Query Host Access request.

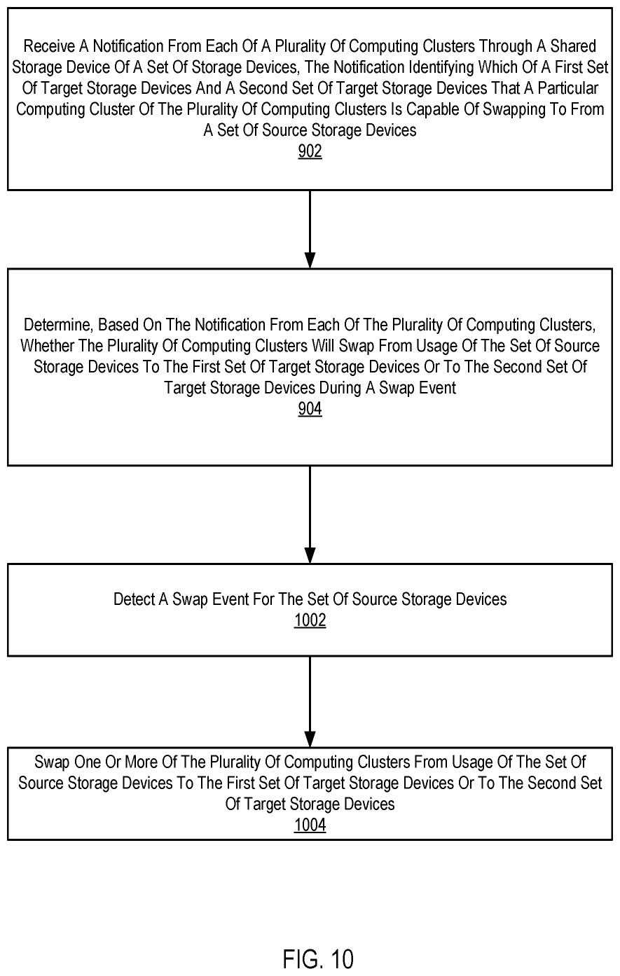

FIG. 10 sets forth a flowchart of another example process for coordinating an unplanned swap event across multiple computing clusters according to aspects of the present disclosure. The process of FIG. 10 is similar to the process described with respect to FIG. 9 and further includes detecting 1002 a swap event for the set of source storage devices. In a particular embodiment, the swap event is detected by receiving the set sysplex status attention interrupt. The process of FIG. 10 further includes swapping 1004 one or more of the plurality of computing clusters from usage of the set of source storage devices to usage of the first set of target storage devices or to the second set of target storage devices.

In an embodiment, the process may further include determining that a first computing cluster of the plurality of computing clusters is unable to swap to the first set of target storage devices and swapping the first computing cluster from usage of the set of source storage devices to usage of an unshared storage device of the second set of target storage devices. In a particular embodiment, the first set of target storage devices includes a first shared target storage device and the second set of target storage devices includes a second shared target storage device. In an embodiment, the process further includes setting a status associated with the first computing cluster indicating that access to the first shared target storage device by the first computing cluster is disabled. In a particular embodiment, the status is indicated in a unit control block associated with the first shared target storage device.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving a notification from each of a plurality of computing clusters through a shared storage device of a set of storage devices, the notification identifying which of a first set of target storage devices and a second set of target storage devices that a particular computing cluster of the plurality of computing clusters is capable of swapping to from a set of source storage devices; and
determining, based on the notification from each of the plurality of computing clusters, whether the plurality of computing clusters will swap from usage of the set of source storage devices to the first set of target storage devices or to the second set of target storage devices during a swap event.

2. The method of claim 1, further comprising:
detecting a swap event for the set of source storage devices; and
swapping one or more of the plurality of computing clusters from usage of the set of source storage devices to usage of the first set of target storage devices.

3. The method of claim 1, further comprising:
determining that a first computing cluster of the plurality of computing clusters is unable to swap to the first set of target storage devices; and
swapping the first computing cluster from usage of the set of source storage devices to usage of an unshared storage device of the second set of target storage devices.

4. The method of claim 3, wherein the first set of target storage devices includes a first shared target storage device and the second set of target storage devices includes a second shared target storage device.

5. The method of claim 4, further comprising:
setting a status associated with the first computing cluster indicating that access to the first shared target storage device by the first computing cluster is disabled.

6. The method of claim 5, wherein the status is indicated in a unit control block associated with the first shared target storage device.

7. The method of claim 1, further comprising:
sending a request message to a storage device associated with each of the plurality of computing clusters; and
receiving a response message from the storage device identifying host devices that are utilizing the storage device.

8. The method of claim 7, wherein the request message comprises a query host access request.

9. The method of claim 1, wherein the notification comprises an attention interrupt message.

10. An apparatus comprising:
a processing device; and
memory operatively coupled to the processing device, wherein the memory stores computer program instructions that, when executed, cause the processing device to:
receive a notification from each of a plurality of computing clusters through a shared storage device of a set of storage devices, the notification identifying which of a first set of target storage devices and a second set of target storage devices that a particular computing cluster of the plurality of computing clusters is capable of swapping to from a set of source storage devices; and
determine, based on the notification from each of the plurality of computing clusters, whether the plurality of computing clusters will swap from usage of the set of source storage devices to the first set of target storage devices or to the second set of target storage devices during a swap event.

11. The apparatus of claim 10, wherein the computer program instructions that, when executed, cause the processing device to:
detect a swap event for the set of source storage devices; and
swap one or more of the plurality of computing clusters from usage of the set of source storage devices to usage of the first set of target storage devices.

12. The apparatus of claim 10, wherein the computer program instructions that, when executed, cause the processing device to:
determine that a first computing cluster of the plurality of computing clusters is unable to swap to the first set of target storage devices; and
swap the first computing cluster from usage of the set of source storage devices to usage of an unshared storage device of the second set of target storage devices.

13. The apparatus of claim 12, wherein the first set of target storage devices includes a first shared target storage device and the second set of target storage devices includes a second shared target storage device.

14. The apparatus of claim 13, wherein the computer program instructions that, when executed, cause the processing device to:
set a status associated with the first computing cluster indicating that access to the first shared target storage device by the first computing cluster is disabled.

15. The apparatus of claim 10, wherein the computer program instructions that, when executed, cause the processing device to:
send a request message to a storage device associated with each of the plurality of computing clusters; and
receive a response message from the storage device identifying host devices that are utilizing the storage device.

16. A computer program product comprising a computer readable storage medium, wherein the computer readable storage medium comprises computer program instructions that, when executed:
receive a notification from each of a plurality of computing clusters through a shared storage device of a set of storage devices, the notification identifying which of a first set of target storage devices and a second set of target storage devices that a particular computing cluster of the plurality of computing clusters is capable of swapping to from a set of source storage devices; and
determine, based on the notification from each of the plurality of computing clusters, whether the plurality of computing clusters will swap from usage of the set of source storage devices to the first set of target storage devices or to the second set of target storage devices during a swap event.

17. The computer program product of claim 16, wherein the computer program instructions that, when executed:
detect a swap event for the set of source storage devices; and
swap one or more of the plurality of computing clusters from usage of the set of source storage devices to usage of the first set of target storage devices.

18. The computer program product of claim 16, wherein the computer program instructions that, when executed:
determine that a first computing cluster of the plurality of computing clusters is unable to swap to the first set of target storage devices; and
swap the first computing cluster from usage of the set of source storage devices to usage of an unshared storage device of the second set of target storage devices.

19. The computer program product of claim 18, wherein the first set of target storage devices includes a first shared target storage device and the second set of target storage devices includes a second shared target storage device.

20. The computer program product of claim 19, wherein the computer program instructions that, when executed:
set a status associated with the first computing cluster indicating that access to the first shared target storage device by the first computing cluster is disabled.
